(19) United States
(12) Patent Application Publication
(10) Pub. No.: US 2023/0311382 A1
(43) Pub. Date: Oct. 5, 2023

(54) DISPLAY DEVICE FOR INJECTION MOLDING, INJECTION MOLDING MACHINE, AND MANAGEMENT DEVICE FOR INJECTION MOLDING

(71) Applicant: SUMITOMO HEAVY INDUSTRIES, LTD., Tokyo (JP)

(72) Inventors: Katsunobu HANO, Chiba-shi (JP); Tomonori HORIKAWA, Chiba-shi (JP); Takuya MATSUNAGA, Chiba-shi (JP)

(21) Appl. No.: 17/993,336

(22) Filed: Nov. 23, 2022

(30) Foreign Application Priority Data
Mar. 31, 2022 (JP) 2022-061221

(51) Int. Cl. B29C 45/17; B29C 45/76

(52) U.S. Cl. CPC B29C 45/1774; B29C 45/76; B29C 2045/7606; B29C 2945/7604; B29C 2945/76006; B29C 2945/76056; B29C 2945/76066; B29C 2945/76013; B29C 2945/76381; B29C 2945/76351; B29C 2945/76391

(57) ABSTRACT

A burden for setting is reduced. A display device for injection molding includes: a receiving unit configured to receive a selection of a defect phenomenon of a molding product manufactured by injection molding; and a display control unit configured to display parameters associated with the defect phenomenon of which the selection is received, in a selectable manner, in which the receiving unit is further configured to receive a selection from the parameters, and the display control unit is further configured to display information regarding the parameter of which the selection is received.

### CROSS-REFERENCE TO RELATED APPLICATIONS

This application claims priority to Japanese Patent Application No. 2022-061221, filed on Mar. 31, 2022, which is incorporated by reference herein in its entirety.

### BACKGROUND

### Technical Field

Certain embodiments of the present invention relate to a display device for injection molding, an injection molding machine, and a management device for injection molding.

### Description of Related Art

In the related art, in an injection molding machine, a technique in has been proposed in which information on various processes during injection molding or setting contents by a user is displayed on a display device.

In the related art, in a case where a setting item displayed on a display device is changed by an operator, a display form of the setting item is changed. Accordingly, when the operator changes the changed setting item again, a burden of searching for the changed setting item can be reduced.

### SUMMARY

A display device for injection molding according to an aspect of the present invention includes: a receiving unit configured to receive a selection of a defect phenomenon of a molding product manufactured by injection molding; and a display control unit configured to display parameters associated with the defect phenomenon of which the selection is received, in a selectable manner, in which the receiving unit is further configured to receive a selection from the parameters, and the display control unit is further configured to display information regarding the parameter of which the selection is received.

### BRIEF DESCRIPTION OF THE DRAWINGS

FIG. 1 is a view illustrating a configuration of a management system according to a first embodiment.

FIG. 2 is a view illustrating a management device, an injection molding machine, and peripheral configurations of the injection molding machine according to the present embodiment.

FIG. 3 is a view illustrating a table structure of a defect phenomenon correspondence storage unit according to the first embodiment.

FIG. 4 is a view illustrating a table structure of a parameter correspondence storage unit according to the first embodiment.

FIG. 5 is a view illustrating an analysis screen of an injection molding machine 3 of which a display is controlled by a display control unit of the management device according to the first embodiment.

FIG. 6 is a view illustrating a quality management screen of the injection molding machine 3 of which a display is controlled by the display control unit of the management device according to the first embodiment.

FIG. 7 is a view showing an example of updating a field of broken line 2 in a case where an update button is pressed.

FIG. 8 is a conceptual view describing a change in a degree of influence stored in a defect phenomenon correspondence storage unit 223 by a changing unit according to the first embodiment.

FIG. 9 is a view illustrating a log information screen output by a control device of an injection molding machine according to a modification example.

### DETAILED DESCRIPTION

In the related art, in a case where a defect phenomenon occurs in a molding product molded by an injection molding machine, it is difficult for the operator to specify a setting item for dealing with the defect phenomenon. For example, in the technique described in the related art, the operator needs to recognize the setting item that needs to be changed.

According to an embodiment of the present invention, an operator is allowed to easily specify a setting item for dealing with a defect phenomenon.

According to the aspect of the present invention, a burden for setting by an operator is reduced.

Hereinafter, embodiments of the present invention will be described with reference to the drawings. In addition, the embodiments described below are merely examples that do not limit the invention, and all the features and combinations thereof described in the embodiments are not necessarily essential to the invention. In each drawing, the same or corresponding reference numerals will be assigned to the same or corresponding configurations, and description thereof will be omitted.

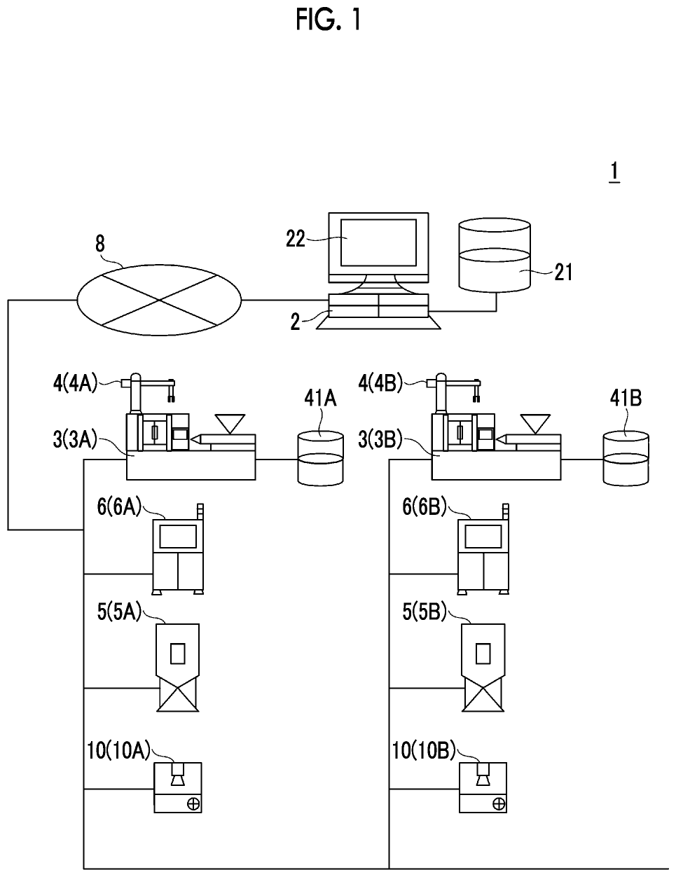

FIG. 1 is a view illustrating a configuration of a management system 1 (an example of an injection molding management system) according to an embodiment. In the present embodiment, in the management system 1, a management device 2, two injection molding machines 3A and 3B (hereinafter, also referred to as an injection molding machine 3 in a case where any injection molding machine is indicated), two take-out robots 4A and 4B (hereinafter, also referred to as a take-out robot 4 in a case where any take-out robot is indicated), two material dryers 5A and 5B (hereinafter, also referred to as a material dryer 5 in a case where any material dryer is indicated), two mold temperature controllers 6A and 6B (hereinafter, also referred to as a mold temperature controller 6 in a case where any mold temperature controller is indicated), and two inspection devices 10A and 10B (hereinafter, also referred to as an inspection device 10 in a case where any inspection device is indicated) are connected to communicate with each other via a communication network 8.

For example, the communication network 8 may include a communication network in a factory where a plurality of the injection molding machines 3 are installed, or may include a public network such as the Internet.

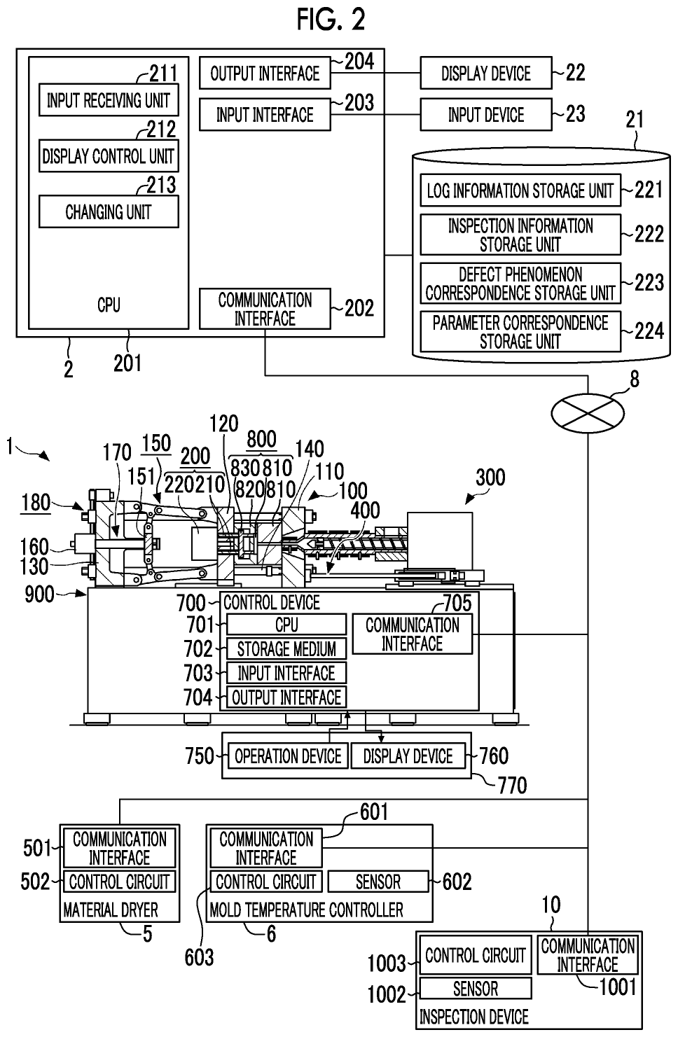

Specifically, the take-out robot 4A takes out a molding product molded by the injection molding machine 3A. The material dryer 5A is a device for drying a molding material (for example, a resin) fed into a feed port of the injection molding machine 3A. The mold temperature controller 6A is a device for adjusting a temperature of a mold unit 800 (see FIG. 2) of the injection molding machine 3A. The inspection device 10A is a device for inspecting the molding product taken out by the take-out robot 4A.

Furthermore, the take-out robot 4B takes out a molding product molded by the injection molding machine 3B. The material dryer 5B is a device for drying a molding material (for example, a resin) fed into a feed port of the injection molding machine 3B. The mold temperature controller 6B is a device for adjusting the temperature of the mold unit 800 (see FIG. 2) of the injection molding machine 3B. The inspection device 10B is a device for inspecting the molding product taken out by the take-out robot 4B.

The management device 2 is a device that manages information on each device of the management system 1. The management device 2 includes a storage device 2l and a display device 22. The management device 2 according to the present embodiment stores information received from each device of the management system 1 in the storage device 21, and displays the information stored in the storage device 21 on the display device 22. In this manner, an operator can recognize a situation in which the injection molding machine 3 is molding the molding product.

FIG. 2 is a view illustrating the management device 2, the injection molding machine 3, and peripheral configurations of the injection molding machine 3 according to the present embodiment. In the example shown in FIG. 2, the material dryer 5, the mold temperature controller 6, and the inspection device 10 are provided as the peripheral configurations of the injection molding machine 3. Furthermore, in the management system 1, the injection molding machine 3, the material dryer 5, the mold temperature controller 6, the inspection device 10, and the management device 2 are connected to each other via the communication network 8.

The material dryer 5 is a device for drying the molding material (for example, a resin) fed into the feed port of the injection molding machine 3, and includes a communication I/F 501 and a control circuit 502.

The control circuit 502 is a device that controls the entire material dryer 5. The communication I/F 501 serves as an interface for communication with a device (for example, the management device 2) connected to the communication network 8. The control circuit 502 of the present embodiment transmits data related to the material dryer 5 to the management device 2 via the communication I/F 501. Examples of the data related to the material dryer 5 (hereinafter, also referred to as dryer data) include a temperature set for drying and actual result data of a drying temperature for the molding material.

The mold temperature controller 6 is a device for adjusting the temperature of the mold unit 800 of the injection molding machine 3, and includes a communication I/F 601, a sensor 602, and a control circuit 603.

The sensor 602 acquires the temperature of the mold unit 800 of the injection molding machine 3. The control circuit 603 is a device that controls the entire mold temperature controller 6. The communication I/F 601 serves as an interface for communication with a device (for example, the management device 2) connected to the communication network 8. The control circuit 603 of the present embodiment adjusts the temperature of the mold unit 800 based on the temperature acquired from the sensor 602. Furthermore, the control circuit 603 transmits data related to the mold temperature controller 6 (hereinafter, also referred to as temperature controller data) to the management device 2 via the communication I/F 601. Examples of the data related to the mold temperature controller 6 include a temperature set for the mold unit 800, actual result data of the temperature of the mold unit 800, and flow rate data of a liquid used for temperature control.

The inspection device 10 is a device for inspecting the molding product molded in the injection molding machine 3, and includes a communication I/F 1001, a sensor 1002, and a control circuit 1003.

The sensor 1002 acquires information (for example, image data) for inspecting the molding product molded by the injection molding machine 3. The control circuit 1003 is a device that controls the entire inspection device 10. The communication I/F 1001 serves as an interface for communication with a device (for example, the management device 2) connected to the communication network 8. The control circuit 1003 of the present embodiment inspects the molding product based on the information acquired from the sensor 1002. For example, the control circuit 1003 of the present embodiment inspects whether or not a defect phenomenon of the molding product occurs. Examples of the defect phenomenon include a short mold, a burr, a sink mark, and a weld line. The defect phenomenon shown in the present embodiment is shown as an example, and other defect phenomena may be included.

The short mold is a defect phenomenon in which a part of the mold unit 800 is cooled in a state in which the molding material is not filled, resulting in an incomplete molding product.

The burr is a defect phenomenon in which the molding material protrudes from the mold unit 800 at the time of molding and an unnecessary portion remains in the molding product.

The sink mark is a defect phenomenon in which, when a shrinkage of the molding material occurs due to cooling and solidification of the molding material in the mold unit 800, the shrinkage of the molding material is not filled, and a surface of the molding product is recessed.

The weld line is a defect phenomenon in which, when the molding material is branched once in the mold unit 800 and the branches of the molding material rejoin, the branches are not properly connected at the junction, and a line or the like remains in the molding product.

The control device 700 transmits inspection result data to the management device 2 via the communication I/F 705. The inspection result data includes whether or not a defect phenomenon occurs in the molding product. Furthermore, the inspection result data includes data indicating the defect phenomenon (at least one of the short mold, the burr, the sink mark, and the weld line) that occurs in a case where the defect phenomenon occurs in the molding product.

### Injection Molding Machine

The injection molding machine 3 will be described. The number of the injection molding machines 3 to be installed in the management system 1 according to the present embodiment is not limited to two, and one or three or more injection molding machines may be installed.

The injection molding machine 3 includes a mold clamping unit 100, an ejector unit 200, an injection unit 300, a moving unit 400, the control device 700, and a frame 900. The control device 700 is disposed in an internal space of the frame 900. Hereinafter, each component of the injection molding machine 3 will be described.

### Mold Clamping Unit

The mold clamping unit 100 performs mold closing, pressurizing, mold clamping, depressurizing, and mold opening of the mold unit 800. The mold unit 800 includes a stationary mold 810 and a movable mold 820. For example, the mold clamping unit 100 is of a horizontal type, and the mold opening and closing direction is a horizontal direction. The mold clamping unit 100 includes a stationary platen 110, a movable platen 120, a toggle support 130, a tie bar 140, a toggle mechanism 150, a mold clamping motor 160, a motion conversion mechanism 170, and a mold space adjustment mechanism 180.

The stationary platen 110 is fixed to the frame 900. The stationary mold 810 is attached to a surface of the stationary platen 110 facing the movable platen 120. The movable platen 120 is disposed to be movable in the mold opening and closing direction with respect to the frame 900. The movable mold 820 is attached to a surface of the movable platen 120 facing the stationary platen 110. By causing the movable platen 120 to advance and retreat with respect to the stationary platen 110, mold closing, pressurizing, mold clamping, depressurizing, and mold opening of the mold unit 800 are performed. The toggle support 130 is disposed at an interval from the stationary platen 110, and is placed on the frame 900 to be movable in the mold opening and closing direction. The tie bar 140 connects the stationary platen 110 and the toggle support 130 to each other at an interval in the mold opening and closing direction.

The toggle mechanism 150 is disposed between the movable platen 120 and the toggle support 130, and moves the movable platen 120 in the mold opening and closing direction with respect to the toggle support 130. The toggle mechanism 150 is configured to include a crosshead 151, a pair of link groups, and the like. When the crosshead 151 is caused to advance and retreat with respect to the toggle support 130, the pair of link groups are bent and stretched, and the movable platen 120 advances and retreats with respect to the toggle support 130. The mold clamping motor 160 is attached to the toggle support 130, and operates the toggle mechanism 150. The motion conversion mechanism 170 converts a rotary motion of the mold clamping motor 160 into a linear motion of the crosshead 151 to operate the toggle mechanism 150.

The mold clamping unit 100 performs a mold closing process, a pressurizing process, a mold clamping process, a depressurizing process, and a mold opening process under the control of the control device 700.

In the mold closing process, the mold clamping motor 160 is driven to cause the crosshead 151 to advance to a mold closing completion position at a set movement speed, thereby causing the movable platen 120 to advance such that the movable mold 820 touches the stationary mold 810.

In the pressurizing process, the mold clamping motor 160 is further driven to cause the crosshead 151 to further advance from the mold closing completion position to a mold clamping position, thereby generating a mold clamping force.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 is formed between the movable mold 820 and the stationary mold 810, and the injection unit 300 fills the cavity space 801 with a liquid molding material. A molding product is obtained by solidifying the molding material filled therein.

In the depressurizing process, the mold clamping motor 160 is driven to cause the crosshead 151 to retreat from the mold clamping position to a mold opening start position such that the movable platen 120 retreats to reduce the mold clamping force. The mold opening start position and the mold closing completion position may be the same position.

In the mold opening process, the mold clamping motor 160 is driven to cause the crosshead 151 to retreat from the mold opening start position to a mold opening completion position at a set movement speed such that the movable platen 120 retreats and the movable mold 820 is separated from the stationary mold 810. Thereafter, the ejector unit 200 ejects the molding product from the movable mold 820.

In a case where a mold space of the mold unit 800 is changed due to replacement of the mold unit 800 or a temperature change in the mold unit 800, mold space adjustment is performed so that a predetermined mold clamping force is obtained during the mold clamping. The mold space adjustment mechanism 180 performs the mold space adjustment by adjusting the interval between the stationary platen 110 and the toggle support 130. For example, a time for the mold space adjustment is determined from an end point of a molding cycle to a start point of a subsequent molding cycle.

### Ejector Unit

The ejector unit 200 is attached to the movable platen 120, and advances and retreats together with the movable platen 120. The ejector unit 200 performs an ejection process under the control of the control device 700. In the ejection process, an ejector rod 210 is caused to advance from a standby position to an ejection position at a set movement speed by a drive mechanism 220 such that a movable member 830 advances to eject the molding product. Thereafter, the ejector rod 210 is caused to retreat at a set movement speed by the drive mechanism 220, and the movable member 830 is caused to retreat to the original standby position.

### Injection Unit

The injection unit 300 is disposed to be able to advance and retreat with respect to the mold unit 800. The injection unit 300 touches the mold unit 800, and fills the cavity space 801 inside the mold unit 800 with the molding material. The injection unit 300 performs a plasticizing process, a filling process, and a holding pressure process under the control of the control device 700. The filling process and the holding pressure process may be collectively referred to as an injection process. In the plasticizing process, a predetermined amount of the liquid molding material is accumulated. In the filling process, the cavity space 801 inside the mold unit 800 is filled with the liquid molding material accumulated in the plasticizing process. In the holding pressure process, a holding pressure of the molding material is maintained at a setting pressure.

### Moving Unit

The moving unit 400 causes the injection unit 300 to advance and retreat with respect to the mold unit 800.

### Control Device

For example, the control device 700 is configured to include a computer, and has a central processing unit (CPU) 701, a storage medium 702 such as a memory, an input interface 703, an output interface 704, and a communication interface 705 as shown in FIG. 2. The control device 700 performs various types of control by causing the CPU 701 to execute a program stored in the storage medium 702. In addition, the control device 700 receives a signal from the outside through the input interface 703, and transmits the signal to the outside through the output interface 704.

The control device 700 repeatedly performs the plasticizing process, the mold closing process, the pressurizing process, the mold clamping process, the filling process, the holding pressure process, a cooling process, the depressurizing process, the mold opening process, and the ejection process, thereby repeatedly manufacturing the molding product. A series of operations for obtaining the molding product, for example, an operation from the start of the plasticizing process to the start of the subsequent plasticizing process, will be referred to as a “shot” or a “molding cycle”. In addition, a time required for one shot will be referred to as a “molding cycle time” or a “cycle time”.

For example, one molding cycle has the plasticizing process, the mold closing process, the pressurizing process, the mold clamping process, the filling process, the holding pressure process, the cooling process, the depressurizing process, the mold opening process, and the ejection process in this order. The order described here is the order of the start times of the respective processes. The filling process, the holding pressure process, and the cooling process are performed during the mold clamping process. The start of the mold clamping process may coincide with the start of the filling process. The completion of the depressurizing process coincides with the start of the mold opening process.

A plurality of processes may be performed at the same time in order to shorten the molding cycle time.

One molding cycle may include a process other than the plasticizing process, the mold closing process, the pressurizing process, the mold clamping process, the filling process, the holding pressure process, the cooling process, the depressurizing process, the mold opening process, and the ejection process.

The control device 700 is connected to an operation device 750 and to a display device 760. The operation device 750 receives an input operation by a user, and outputs a signal corresponding to the input operation to the control device 700. The display device 760 displays a display screen corresponding to the input operation in the operation device 750 under the control of the control device 700.

The display screen is used for setting the injection molding machine 3 and the like. A plurality of display screens are prepared, and the display screens may be switched and displayed, or may be displayed in an overlapping manner. The user operates the operation device 750 while looking at the display screen displayed on the display device 760 to perform settings (including an input of a set value) of the injection molding machine 3.

For example, the operation device 750 and the display device 760 may be integrated with each other in a form of a touch panel 770. Although the operation device 750 and the display device 760 of the present embodiment are integrated with each other, the operation device 750 and the display device 760 may be provided independently. In addition, a plurality of the operation devices 750 may be provided.

The communication interface 705 is an interface for communication with the management device 2 connected via the communication network 8.

In a case where the molding product is molded, the CPU 701 reads a measurement result from a sensor (not shown) provided in the injection molding machine 3 and setting information set in the injection molding machine 3 from the storage medium 702 and transmits the read information to the management device 2 as log information via the communication interface 705.

The log information is information for each shot for manufacturing the molding product via the injection molding machine 3, and is information including the setting information set for manufacturing the molding product, and measurement information measured by the sensor when the molding product is molded.

### Management Device

The management device 2 (an example of a display device) is a device for managing the injection molding machine 3, and includes a CPU 201, a communication interface 202, an input interface 203, and an output interface 204.

The management device 2 is connected to the storage device 21. The storage device 21 is a read/write non-volatile auxiliary storage device, and, for example, a hard disk drive (HDD) or a solid state drive (SSD) is used.

The storage device 21 stores a log information storage unit 221, an inspection information storage unit 222, a defect phenomenon correspondence storage unit 223, and a parameter correspondence storage unit 224.

The log information storage unit 221 stores log information regarding manufacturing of the molding product via the injection molding machine 3. For example, the log information storage unit 221 stores the log information transmitted from the injection molding machine 3, the dryer data transmitted from the material dryer 5, and the temperature controller data transmitted from the mold temperature controller 6, in association with each shot. Accordingly, the management device 2 can hold the set value for each molding product manufactured by the injection molding machine 3 and actual values measured during the manufacturing of the molding product in association with each other for each shot.

The inspection information storage unit 222 stores the inspection result data indicating an inspection result of the molding product by the injection molding machine 3. For example, the inspection information storage unit 222 stores the inspection result data transmitted from the inspection device 10 for each shot. Accordingly, the management device 2 can hold the inspection result data for each molding product manufactured by the injection molding machine 3 for each shot. The inspection result data includes information indicating whether or not a defect phenomenon has occurred, and information (for example, a short mold, a burr, a sink mark, and a weld line) that specifies the defect phenomenon in a case where the defect phenomenon occurs.

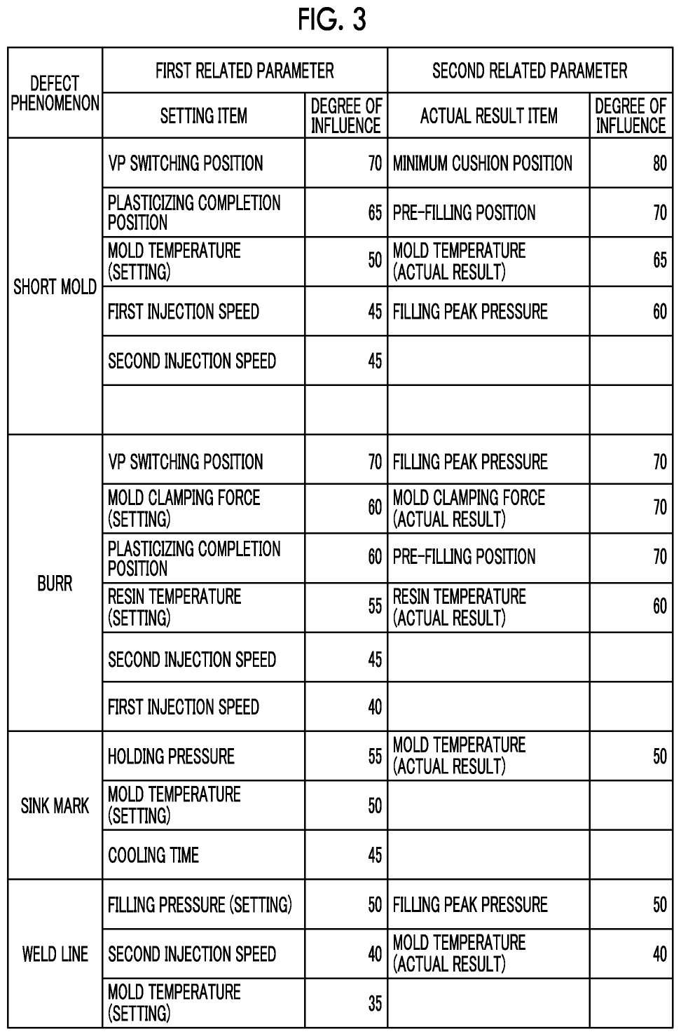

The defect phenomenon correspondence storage unit 223 stores parameters that are considered to have an influence on the defect phenomenon that occurs in the molding product manufactured by injection molding. FIG. 3 is a view illustrating a table structure of the defect phenomenon correspondence storage unit 223 according to the present embodiment.

As shown in FIG. 3, the defect phenomenon correspondence storage unit 223 (an example of a first storage unit) stores a defect phenomenon, a first related parameter related to the defect phenomenon, and a second related parameter related to the defect phenomenon in association with each other. The defect phenomenon is as described above, and description thereof will be omitted.

In the first related parameter, a setting item (an example of a first parameter) set for manufacturing the molding product, and a degree of influence indicating the degree to which a set value of the setting item has an influence on the defect phenomenon are associated with each other.

In the second related parameter, an actual result item (an example of a second parameter) indicating an actual result measured during the manufacturing of the molding product, a degree of influence indicating the degree to which an actual value by the actual result item has an influence on the defect phenomenon are associated with each other.

The degree of influence is information indicating the degree of influence on the defect phenomenon, and, for example, a preset value may be set at the time of shipment of the injection molding machine 3. For example, the degree of influence may be a value preset by an expert. In addition, the degree of influence may be a value set according to a value of a correlation which is calculated between a preset set value or a measured actual value and a corresponding defect phenomenon when an actual molding product is manufactured. The degree of influence is not limited only to a numerical value, and any information may be used as long as the information can enable recognition of the degree of influence on the defect phenomenon. For example, characters, symbols, and signs may be used as the degree of influence. As a specific example of the degree of influence, symbols such as “A”, “B”, or “C” may be used.

The degree of influence is updated to a more appropriate value while the injection molding machine 3 manufactures the molding product. An updating method will be described later.

For the short mold, which is one type of the defect phenomena, as setting items of the first related parameter, a VP switching position (a switching position from the filling process of the screw 330 to the holding pressure process), a plasticizing completion position (a position of the screw 330 at the end of the plasticizing), a mold temperature (setting) (a temperature preset in the mold unit 800), a first injection speed (a speed of a first stage at the time of the injection of the screw 330), and a second injection speed (a speed of a second stage at the time of the injection of the screw 330) are associated. The degree of influence of each setting item on the short mold is “70” for the VP switching position, “65” for the plasticizing completion position, “50” for the mold temperature (setting), “45” for the first injection speed, and “45” for the second injection speed.

For the short mold, which is one type of the defect phenomena, as actual result items of the second related parameter, a minimum cushion position (a position when the screw 330 is moved to a frontmost position when a pressure is applied after the mold unit 800 is filled with the molding material), a pre-filling position (a position to which the screw 330 is caused to advance for a constant density), a mold temperature (actual result) (the temperature measured as the mold unit 800), and a filling peak pressure (a peak value of the pressure when the molding material is filled) are associated. The degree of influence of each setting item on the short mold is “80” for the minimum cushion position, “70” for the pre-filling position, “65” for the mold temperature (actual result), and “60” for the filling peak pressure.

For the burr, which is one type of the defect phenomena, as setting items of the first related parameter, the VP switching position, the mold clamping force (setting), the plasticizing completion position, a resin temperature (setting) (a temperature of the molding material at the time of injection), the second injection speed, and the first injection speed are associated. The degree of influence of each setting item on the burr is “70” for the VP switching position, “60” for the mold clamping force (setting), “60” for the plasticizing completion position, “60” for the resin temperature (setting), “45” for the second injection speed, and “40” for the first injection speed.

For the burr, which is one type of the defect phenomena, as actual result items of the second related parameter, the filling peak pressure, the mold clamping force (actual result), the pre-filling position, and the resin temperature (actual result) are associated. The degree of influence of each setting item on the burr is “70” for the filling peak pressure, “70” for the mold clamping force (actual result), “70” for the pre-filling position, and “60” for the resin temperature (actual result).

For the sink mark, which is one type of the defect phenomena, as setting items of the first related parameter, the holding pressure (the holding pressure set in the holding pressure process), the mold temperature (setting), and a cooling time (a cooling time in the cooling process) are associated. The degree of influence of each setting item on the sink mark is “55” for the holding pressure, “50” for the mold temperature (setting), and “45” for the cooling time.

For the sink mark, which is one type of the defect phenomena, as actual result items of the second related parameter, the mold temperature (actual result) is associated. The degree of influence of each setting item on the sink mark is “50” for the mold temperature (actual result).

For the weld line, which is one type of the defect phenomena, as setting items of the first related parameter, a filling pressure (setting) (a pressure set in the filling process), the second injection speed, and the mold temperature (setting) are associated. The degree of influence of each setting item on the weld line is “50” for the filling pressure (setting), “40” for the second injection speed, and “35” for the mold temperature (setting).

For the weld line, which is one type of the defect phenomena, as actual result items of the second related parameter, the filling peak pressure and the mold temperature (actual result) are associated. The degree of influence of each setting item on the weld line is “50” for the filling peak pressure and “40” for the mold temperature (actual result).

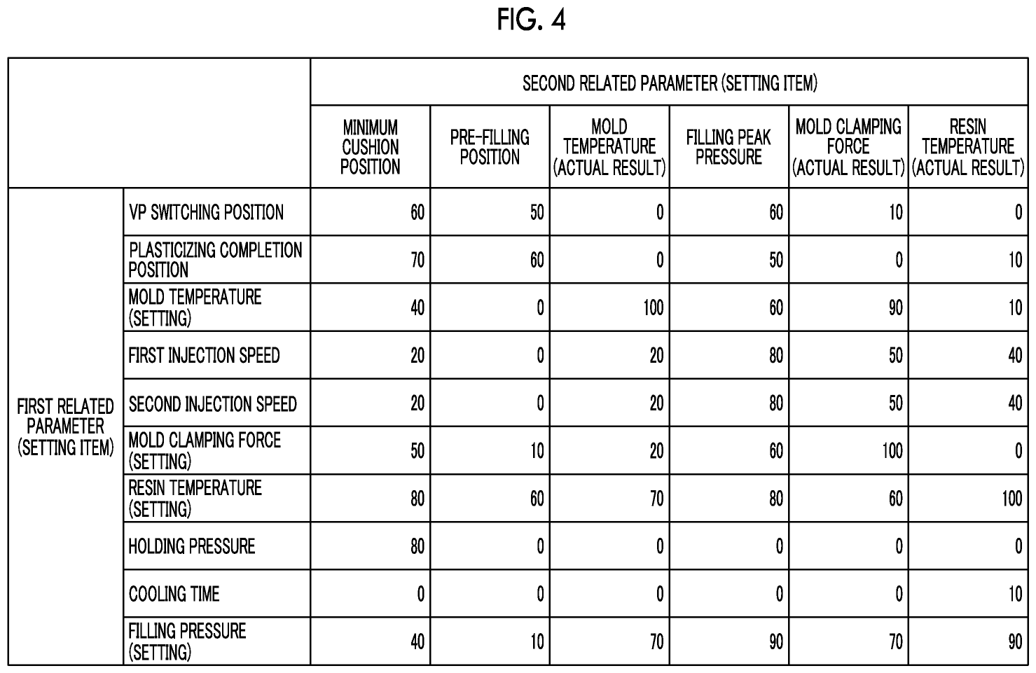

The parameter correspondence storage unit 224 (an example of a second storage unit) stores the degree of relation between the first related parameter (setting items) and the second related parameter (actual result items). FIG. 4 is a view illustrating a table structure of the parameter correspondence storage unit 224 according to the present embodiment. As shown in FIG. 4, the degree of relation is set for each correspondence between the first related parameter (setting items) and the second related parameter (actual result items). As for the degree of relation shown in FIG. 4, the larger the value is set, the higher the relation between the setting item and the actual result item is.

For example, the relation between the VP switching position and the minimum cushion position is “60”, the relation between the plasticizing completion position and the minimum cushion position is “70”, the relation between the mold temperature (setting) and the minimum cushion position is “40”, the relation between the first injection speed and the minimum cushion position is “20”, and the relation between the second injection speed and the minimum cushion position is “20”.

The setting items set for manufacturing the molding product and the actual result items indicating the actual results measured at the time of manufacturing the molding product have an influence on each other. Therefore, in a case where the operator selects any actual result item, the setting item related to the actual result item is presented, whereby an operation burden of the operator is reduced.

For example, in a case where the defect phenomenon is the short mold, in a case where the operator selects the minimum cushion position as the actual result item, the management device 2 may present the plasticizing completion position having the highest degree of relation among the candidates for the setting items of the short mold (the VP switching position, the plasticizing completion position, the mold temperature (setting), the first injection speed, and the second injection speed).

The management device 2 performs various types of control by causing the CPU 701 to execute a program stored in the storage device 21 or the like. In addition, the control device 700 receives a signal from the outside through the input interface 703, and transmits the signal to the outside through the output interface 704.

Each functional block of the CPU 201 according to the present embodiment is conceptual, and may not necessarily be configured to be physical as shown. All or a portion of each functional block can be configured to be functionally or physically distributed and integrated in any desired unit. Each processing function performed in each functional block is realized by a program in which all or any desired partial functions are performed by the CPU 201. Alternatively, each functional block may be realized as hardware using a wired logic. The CPU 201 realizes an input receiving unit 211, a display control unit 212, and a changing unit 213.

The input receiving unit 211 receives information input from the operator for an item displayed on a display screen via an input device 23.

The display control unit 212 displays the display screen based on the information received by the input receiving unit 211 on the display device 22. As described above, in the present embodiment, the display screen is updated based on the information input by the operator.

In the management device 2 according to the present embodiment, a defect phenomenon during manufacturing of the molding material can be investigated with reference to setting data, actual result data, and the inspection result data for each shot stored in the log information storage unit 221 by using the above-described configuration.

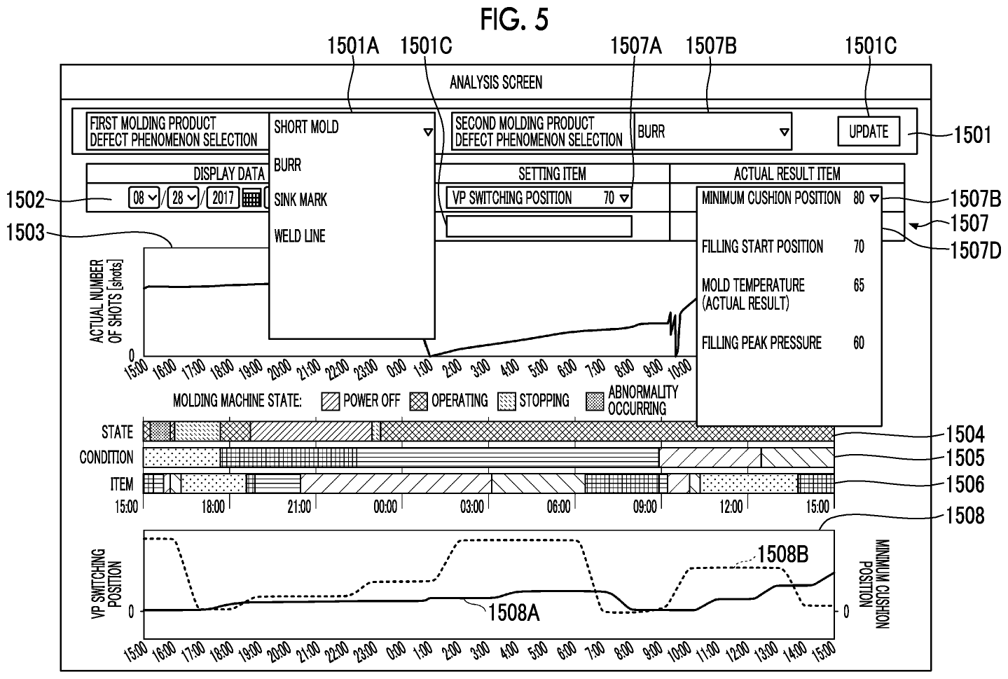

FIG. 5 is a view illustrating an analysis screen of the injection molding machine 3 of which a display is controlled by the display control unit 212 according to the present embodiment. In the analysis screen shown in FIG. 5, a defect phenomenon selection field 1501, a display data range field 1502, a number of shots field 1503, a state field 1504, a condition field 1505, an item field 1506, an item selection field 1507, and a graph display field 1508 are included. For example, the analysis screen shown in FIG. 5 is an analysis screen of the injection molding machine 3A, but the analysis screen may include contents of a plurality of the injection molding machines 3. In the analysis screen illustrated in FIG. 5, changes in actual values and set values collected from the injection molding machine 3 with time on a horizontal axis can be confirmed graphically. In addition, information on an event such as operating conditions of the injection molding machine 3, a change in molding products, and a change in molding conditions can also be confirmed.

The display data range field 1502 is a field that receives setting of a date and time range to be displayed in the graph display field 1508 or the like on the analysis screen. In the example shown in FIG. 5, “from 15:00 on Aug. 28, 2017 to 15:00 on Aug. 29, 2017” is set.

The number of shots field 1503 indicates the number of shots per unit time (actual number of shots) in the date and time range set in the display data range field 1502.

The state field 1504 indicates a state of the injection molding machine 3A. In the example shown in FIG. 5, in the date and time range set in the display data range field 1502, a change in state depending on “power OFF”, “operating”, “stopping”, and “abnormality occurring” is shown.

The condition field 1505 indicates a condition name for molding by the injection molding machine 3A, in other words, a change in a product to be molded. In the example shown in FIG. 5, in the date and time range set in the display data range field 1502, a change in the product to be molded over time is shown as a change in color (shading).

The item field 1506 indicates a change in a set value set for each setting item in the injection molding machine 3A. In the example shown in FIG. 5, in the date and time range set in the display data range field 1502, a set value of which setting is changed over time is shown as a change in color (shading).

In the present embodiment, information regarding an item selected in the item selection field 1507 is displayed in the graph display field 1508. Accordingly, the operator can confirm set values and actual values when a defect phenomenon occurs in the molding product with reference to the graph display field 1508. However, in a case of an unskilled operator, it is difficult to select an item (for example, a setting item or an actual result item) corresponding to the defect phenomenon in the graph display field 1508. Therefore, in the present embodiment, in a case where the defect phenomenon is selected in the defect phenomenon selection field 1501, items that can be selected among items displayed in the graph display field 1508 are limited.

The defect phenomenon selection field 1501 includes a first molding product defect phenomenon selection field 1501A, a second molding product defect phenomenon selection field 1501B, and an update button 1501C.

For example, the first molding product defect phenomenon selection field 1501A is a field for selecting a defect phenomenon from the short mold, the burr, the sink mark, and the weld line. Similarly, the second molding product defect phenomenon selection field 1501B is a field for selecting a defect phenomenon from the short mold, the burr, the sink mark, and the weld line. In the present embodiment, a pull-down menu format for selecting the defect phenomenon in the first molding product defect phenomenon selection field 1501A and the second molding product defect phenomenon selection field 1501B is used, but other formats may also be used.

As described above, the input receiving unit 211 receives the selection of the defect phenomenon of the molding product manufactured by the injection molding for each of the first molding product defect phenomenon selection field 1501A and the second molding product defect phenomenon selection field 1501B. After receiving the selection of the defect phenomenon in the first molding product defect phenomenon selection field 1501A and the second molding product defect phenomenon selection field 1501B, the input receiving unit 211 receives pressing of the update button 1501C. Accordingly, candidates for the setting item and the actual result item displayed in the item selection field 1507 are updated based on the selected defect phenomenon.

The item selection field 1507 includes a first setting item selection field 1507A, a first actual result item selection field 1507B, a second setting item selection field 1507C, and a second actual result item selection field 1507D.

The first setting item selection field 1507A is a field for selecting a setting item for which a set value is displayed in the graph display field 1508. The first actual result item selection field 1507B is a field for selecting an actual result item for which an actual value is displayed in the graph display field 1508.

In addition, in a case where the input receiving unit 211 receives the selection of the defect phenomenon in the first molding product defect phenomenon selection field 1501A and simultaneously receives the pressing of the update button 1501C, the display control unit 212 according to the present embodiment displays setting items associated in the defect phenomenon correspondence storage unit 223 with the defect phenomenon of which the selection is received, in the first setting item selection field 1507A.

Similarly, in the case where the input receiving unit 211 receives the selection of the defect phenomenon in the first molding product defect phenomenon selection field 1501A and simultaneously receives the pressing of the update button 1501C, the display control unit 212 according to the present embodiment displays actual result items associated in the defect phenomenon correspondence storage unit 223 with the defect phenomenon of which the selection is received, in the first actual result item selection field 1507B.

In the example illustrated in FIG. 5, in a case where the selection of the “short mold” is received in the first molding product defect phenomenon selection field 1501A, the display control unit 212 displays the selectable actual result items “minimum cushion position”, “filling start position”, “mold temperature (actual result)”, and “filling peak pressure” in order of the degree of influence (an example of a display based on the degree of influence) on the selected defect phenomenon in a selectable manner in a pull-down menu of the first actual result item selection field 1507B. In the present embodiment, an example in which actual result items are displayed in order of the degree of influence is described. However, the present embodiment is not limited to a form in which the actual result items are displayed in order of the degree of influence.

The second setting item selection field 1507C is a field for selecting a setting item for which a set value is displayed in a graph display field (not shown). The second actual result item selection field 1507D is a field for selecting an actual result item for which an actual value is displayed in the graph display field (not shown).

The graph display field (not shown) is a field displayed below the graph display field 1508, and is displayed in a case where the input receiving unit 211 receives a scroll down operation from the operator.

The graph display field 1508 displays the set value in the setting item selected in the first setting item selection field 1507A and the actual value in the actual result item selected in the first actual result item selection field 1507B. In the graph display field 1508 according to the present embodiment, changes in the set value and the actual value in the date and time range set in the display data range field 1502 are shown.

In the example shown in FIG. 5, the input receiving unit 211 receives the selection of the setting item“VP switching position” in the first setting item selection field 1507A, and simultaneously receives the selection of the setting item “minimum cushion position” in the second setting item selection field 1507C.

Accordingly, the display control unit 212 displays a line 1508A indicating the set value of the setting item “VP switching position” of which the selection is received, and a line 1508B indicating the actual value of the actual result item “minimum cushion position” of which the selection is received. As described above, in the present embodiment, in the case where the selection of the defect phenomenon is received, a graph related to the set value of the setting item selected by the operator among the setting items and the actual result items associated with the defect phenomenon and a graph related to the actual value of the actual result item (an example of information regarding the setting item or the actual result item (an example of the parameter)) are displayed.

The graph related to the set value is a line showing a change in the set value over time. The graph related to the actual value is a line showing a change in the actual value over time.

Accordingly, the operator can confirm the set value and the actual value that are presumed to have a high relation to the defect phenomenon, and thus it is possible to reduce a burden of identifying a cause of the defect phenomenon.

A screen different from the analysis screen displayed by the display control unit 212 will be described.

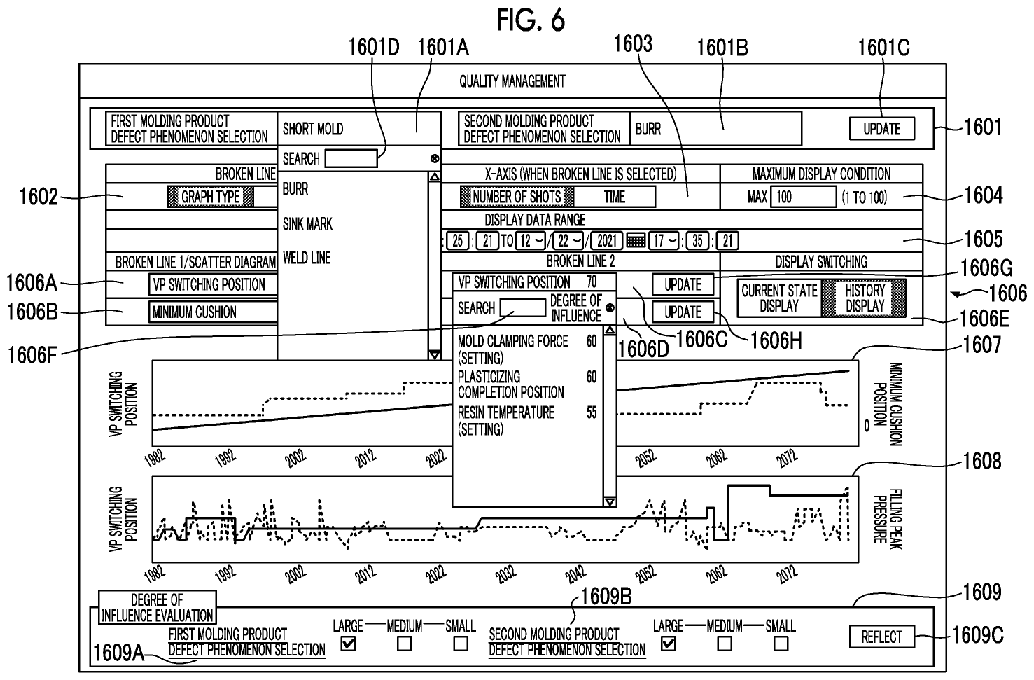

FIG. 6 is a view illustrating a quality management screen of the injection molding machine 3 of which a display is controlled by the display control unit 212 according to the present embodiment. In the quality management screen illustrated in FIG. 6, a defect phenomenon selection field 1601, a graph type selection field 1602, an X-axis display unit selection field 1603, a maximum display number field 1604, a display data range field 1605, an item selection field 1606, a first graph display field 1607, a second graph display field 1608, and a degree of influence evaluation field 1609 are included. For example, the quality management screen shown in FIG. 6 is a quality management screen of the injection molding machine 3A, but the quality management screen may include contents of a plurality of the injection molding machines 3.

The graph type selection field 1602 is a field for selecting a graph type displayed in the first graph display field 1607. In the present embodiment, selection can be made from “broken line” and “scatter diagram”.

The X-axis display unit selection field 1603 is a field for selecting an X-axis type displayed in the first graph display field 1607 and the second graph display field 1608. In the present embodiment, selection can be made from “number of shots” and “time”. In the present embodiment, the selection of the X-axis type is limited to a case where “broken line” is selected in the graph type selection field 1602.

The maximum display number field 1604 is a field that receives setting of the number of shots displayed in the first graph display field 1607 and the second graph display field 1608.

The display data range field 1605 sets a date and time range displayed in the first graph display field 1607 and the second graph display field 1608. In the example shown in FIG. 6, “from 17:25:25 on Dec. 22, 2021 to 17:35:21 on Dec. 22, 2021” is set.

The defect phenomenon selection field 1601 includes a first molding product defect phenomenon selection field 1601A, a second molding product defect phenomenon selection field 1601B, and an update button 1601C.

For example, the first molding product defect phenomenon selection field 1601A is a field for selecting a defect phenomenon from the short mold, the burr, the sink mark, and the weld line. Similarly, the second molding product defect phenomenon selection field 1601B is a field for selecting a defect phenomenon from the short mold, the burr, the sink mark, and the weld line. In the example shown in FIG. 6, a search field 1601D is shown. The operator can search for other defect phenomena not displayed in the list from the search field 1601D.

The input receiving unit 211 receives the selection of the defect phenomenon of the molding product manufactured by the injection molding for each of the first molding product defect phenomenon selection field 1601A and the second molding product defect phenomenon selection field 1601B. The input receiving unit 211 receives the pressing of the update button 1601C after receiving the selection of the defect phenomenon in the first molding product defect phenomenon selection field 1601A and the second molding product defect phenomenon selection field 1601B. Accordingly, candidates for the setting item and the actual result item displayed in the item selection field 1606 are updated based on the selected defect phenomenon.

The item selection field 1606 includes a field of broken line 1/scatter diagram, a field of broken line 2, and a display switching field 1606E.

The display switching field 1606E displays “current state display” for displaying a current state of the injection molding machine 3 and “history display” for displaying past actual results of the injection molding machine 3 in a selectable manner. In the present embodiment, a case where “history display” is selected will be described.

The field of broken line 1/scatter diagram is a setting field for displaying information (for example, the setting item or the actual result item) regarding the defect phenomenon selected in the first molding product defect phenomenon selection field 1601A in the first graph display field 1607.

The field of the broken line 1/scatter diagram includes a first setting item selection field 1606A and a first actual result item selection field 1606B.

The first setting item selection field 1606A is a field for selecting a setting item for which a set value is displayed in the first graph display field 1607. The first actual result item selection field 1606B is a field for selecting an actual result item for which an actual value is displayed in the first graph display field 1607.

The field of broken line 2 is a setting field for displaying information (for example, the setting item or the actual result item) regarding the defect phenomenon selected in the second molding product defect phenomenon selection field 1601B in the second graph display field 1608.

The field of broken line 2 includes a second setting item selection field 1606C and a second actual result item selection field 1606D.

The second setting item selection field 1606C is a field for selecting a setting item for which a set value is displayed in the second graph display field 1608. The second actual result item selection field 1606D is a field for selecting an actual result item for which an actual value is displayed in the second graph display field 1608.

In the example shown in FIG. 6, in a case where the selection of “burr” is received in the second molding product defect phenomenon selection field 1601B, the display control unit 212 displays the selectable actual result items “VP switching position”, “mold clamping force (setting)”, “plasticizing completion position”, and “resin temperature (setting)” in order of the degree of influence (an example of a display based on the degree of influence) on the selected defect phenomenon in a selectable manner in a pull-down menu of the second setting item selection field 1606C. Furthermore, in the example shown in FIG. 6, a search field 1606F is shown. A setting item that is not displayed can be searched for from the search field 1606F.

In addition, an update button 1606G is provided in the second setting item selection field 1606C, and an update button 1606H is provided in the second actual result item selection field 1606D.

The update button 1606G is provided to update the second actual result item selection field 1606D with the actual result item related to the setting item set in the second setting item selection field 1606C. The update button 1606H is provided to update the second setting item selection field 1606C with the setting item related to the actual result item set in the second actual result item selection field 1606D.

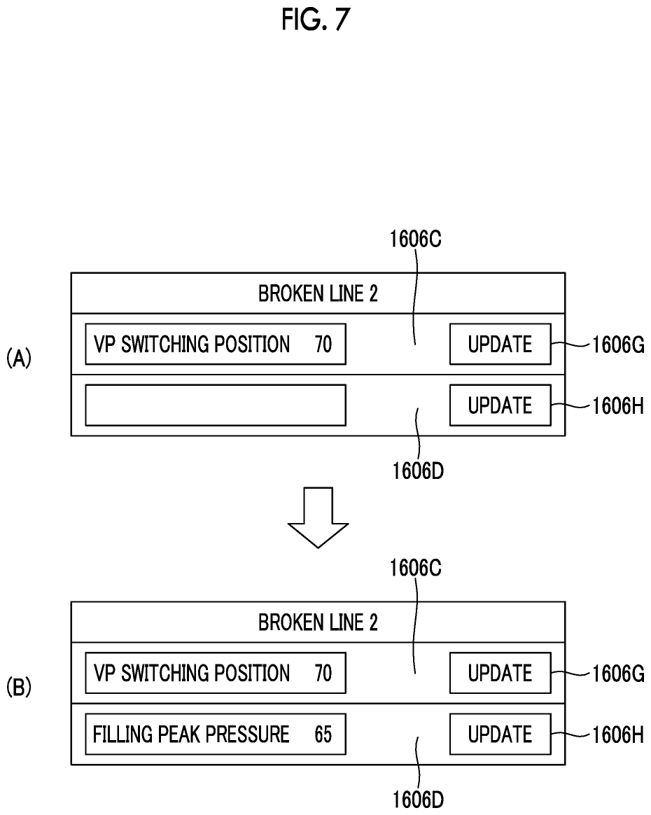

FIG. 7 is a view showing an example of updating the field of broken line 2 in a case where the update button 1606G is pressed. In the example shown in FIG. 7, “VP switching position” is set in the second setting item selection field 1606C in the field of broken line 2. In a case where the input receiving unit 211 receives the pressing of the update button 1606G, the display control unit 212 automatically selects and displays “filling peak pressure” having the highest degree of relation to “VP switching position” for the already selected defect phenomenon “burr”, in the second actual result item selection field 1606D.

In addition, in a case where the update button 1606H is pressed, the setting item having the highest degree of relation to the actual result item set in the second actual result item selection field 1606D is automatically selected and displayed in the second setting item selection field 1606C.

As described above, in a case where the input receiving unit 211 receives the selection of the setting item in the second setting item selection field 1606C, the display control unit 212 selects and displays the actual result item associated in the parameter correspondence storage unit 224 with the setting item of which the selection is received with the highest degree of relation among the actual result items associated with the selected defect phenomenon, in the second actual result item selection field 1606D. The same applies to a case where the selection of the actual result item is received in the second actual result item selection field 1606D. Furthermore, the display is not limited to the field of broken line 2, and the same applies to the field of broken line 1/scatter diagram, so that description thereof will be omitted.

Returning to FIG. 6, the first graph display field 1607 displays the set value in the setting item selected in the first setting item selection field 1606A and the actual value in the actual result item selected in the first actual result item selection field 1606B. In the first graph display field 1607 according to the present embodiment, changes in the set value and the actual value are shown in the number set in the maximum display number field 1604 in the range set in the display data range field 1605.

In the example shown in FIG. 6, in the first graph display field 1607 a line 1607A indicating a set value of the setting item “VP switching position”, which is presumed to have a high degree of influence on the defect phenomenon “short mold”, and a line 1607B indicating an actual value of the actual result item “minimum cushion position” are shown.

In the second graph display field 1608, a line 1608A indicating a set value of the setting item “VP switching position”, which is presumed to have a high degree of influence on the defect phenomenon “burr”, and a line 1608B indicating an actual value of the actual result item “filling peak pressure” are shown. As shown in FIG. 7, the actual result item “filling peak pressure” is automatically set as the actual result item having the highest degree of relation to “VP switching position” for the defect phenomenon “burr”.

The degree of influence evaluation field 1609 includes a first molding product defect phenomenon selection field 1609A, a second molding product defect phenomenon selection field 1609B, and a reflect button 1609C.

The first molding product defect phenomenon selection field 1609A is a selection field for updating the degree of influence between the setting item and the actual result item displayed in the first graph display field 1607. When the input receiving unit 211 receives a check of any one of “large”, “medium”, and “small” from the selection field and then receives the pressing of the reflect button 1609C, the changing unit 213 updates the degree of influence between the setting item and the actual result item. For example, in a case where “large” is checked, the degree of influence is increased, in a case where “medium” is checked, the degree of influence is not changed, and in a case where “small” is checked, the degree of influence is decreased.

The second molding product defect phenomenon selection field 1609B is a selection field for updating the degree of influence between the setting item and the actual result item displayed in the second graph display field 1608. Updating of the degree of influence is the same as in the first molding product defect phenomenon selection field 1609A, and description thereof will be omitted.

As described above, the display control unit 212 displays a first molding product defect phenomenon selection field 1609A and a second molding product defect phenomenon selection field 1609B (an example of display information) for updating the degree of influence of the setting item and the actual result item.

Then, in the case where the input receiving unit 211 receives a check in the first molding product defect phenomenon selection field 1609A or the second molding product defect phenomenon selection field 1609B and receives the pressing of the reflect button 1609C, the changing unit 213 changes the degree of influence of the setting item and the actual result item corresponding to the selection field to a degree of influence corresponding to the check.

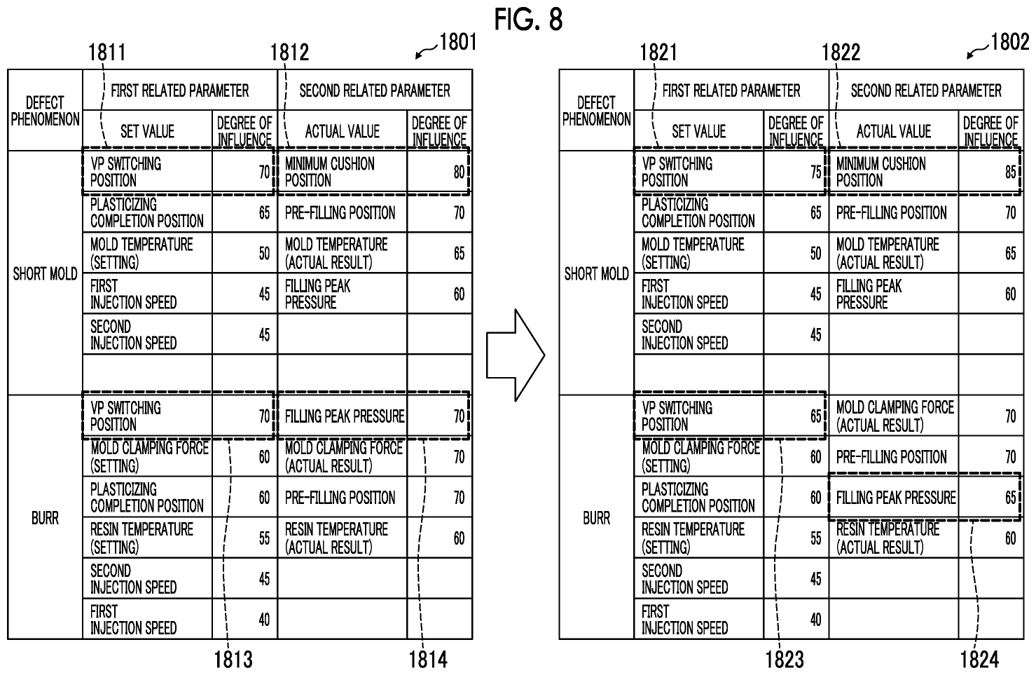

FIG. 8 is a conceptual view describing a change in the degree of influence stored in the defect phenomenon correspondence storage unit 223 by the changing unit 213 according to the present embodiment.

As shown in FIG. 6, the display control unit 212 displays the first molding product defect phenomenon selection field 1609A and the second molding product defect phenomenon selection field 1609B as an example of the display information for updating the degree of influence of the setting item or the actual result item (an example of the parameter).

In the example shown in FIG. 8, the degree of influence is updated in the case where the first molding product defect phenomenon selection field 1609A receives the selection of “large”, and the second molding product defect phenomenon selection field 1609B receives the selection of “small” as shown in FIG. 6. That is, the updating is performed in a case where the operator determines that for the “short mold” selected in the first molding product defect phenomenon selection field 1601A, the VP switching position and the minimum cushion position displayed in the first graph display field 1607 have a high degree of influence, and for the “burr” selected in the second molding product defect phenomenon selection field 1601B, the VP switching position and the filling peak pressure displayed in the second graph display field 1608 have a low degree of influence.

As shown in FIG. 8, in a table 1801 of the defect phenomenon correspondence storage unit 223 before the updating, a degree of influence of “70” is set in a “VP switching position” 1811 and a degree of influence of “80” is set in a “minimum cushion position” 1812 for the “short mold”, and a degree of influence of “70” is set in a “VP switching position” 1813 and a degree of influence of “70” is set in a “filling peak pressure” 1814 for the “burr”.

The changing unit 213 increases the degrees of influence of the “VP switching position” and the “minimum cushion position” of the “short mold” on the basis of the selection of “large” with respect to the first molding product defect phenomenon selection field 1609A. Furthermore, the changing unit 213 decreases the degrees of influence of the “VP switching position” and the “filling peak pressure” of the “burr” on the basis of the selection of “small” with respect to the second molding product defect phenomenon selection field 1609B. In the present embodiment, “5” is added in a case where the degree of influence is increased, and “5” is subtracted in a case where the degree of influence is decreased. In the present embodiment, the numerical value to be increased and the numerical value to be decreased are not limited to “5”, and other numerical values may be used. Furthermore, the present embodiment is not limited to the example in which the degree of influence is changed by addition and subtraction, and multiplication or division may be used.

In a table 1802 of the defect phenomenon correspondence storage unit 223 after the updating, the degree of influence in a “VP switching position” 1821 is changed to “75” and the degree of influence in a “minimum cushion position” 1822 is changed to “85” for the “short mold”, and the degree of influence in a “VP switching position” 1823 is changed to “65” and the degree of influence in a “filling peak pressure” 1824 is changed to “65” for the “burr”.

As described above, in the present embodiment, according to the above-described control, in response to the input to the first molding product defect phenomenon selection field 1609A and the second molding product defect phenomenon selection field 1609B by the operator, the degree of influence stored in the defect phenomenon correspondence storage unit 223 can be updated.

In addition, in the present embodiment, an example of updating the degree of influence based on the input to the first molding product defect phenomenon selection field 1609A and the second molding product defect phenomenon selection field 1609B has been described. However, the present embodiment does not limit the updating of the degree of influence to the method based on the input.

For example, the changing unit 213 may calculate a correlation between the defect phenomenon and the setting item or the actual result item based on the inspection result data and the log information for each mold unit 800 of the injection molding machine 3 and automatically update the degree of influence on the basis of the correlation. Furthermore, the changing unit 213 may be updated with the degree of influence directly input by the expert.

### Modification Example

In the above-described embodiment, an example in which the screen is displayed on the management device 2 has been described. However, in the above-described embodiment, the display of the setting item or the actual result item related to the defect phenomenon is not limited to the management device 2. Therefore, in a modification example, a case where the injection molding machine 3 performs the display will be described.

The injection molding machine 3 according to the present modification example saves the log information transmitted to the management device 2 in the storage medium 702. In addition, the injection molding machine 3 may refer to the inspection result data indicating the inspection result obtained by the inspection device 10 from the management device 2, or may receive the inspection result data from the inspection device 10. In addition, the injection molding machine 3 may refer to the dryer data of the material dryer 5 and the temperature controller data of the mold temperature controller 6 from the management device 2.

In the present modification example, the injection molding machine 3 refers to the defect phenomenon correspondence storage unit 223 and the parameter correspondence storage unit 224 from the management device 2. In addition, the present modification example is not limited to the form to be referred to, and the injection molding machine 3 may store the defect phenomenon correspondence storage unit 223 and the parameter correspondence storage unit 224.

The CPU 701 related to the control device 700 of the injection molding machine 3 realizes the input receiving unit, the display control unit, and the changing unit by executing the program stored in the storage medium 702.

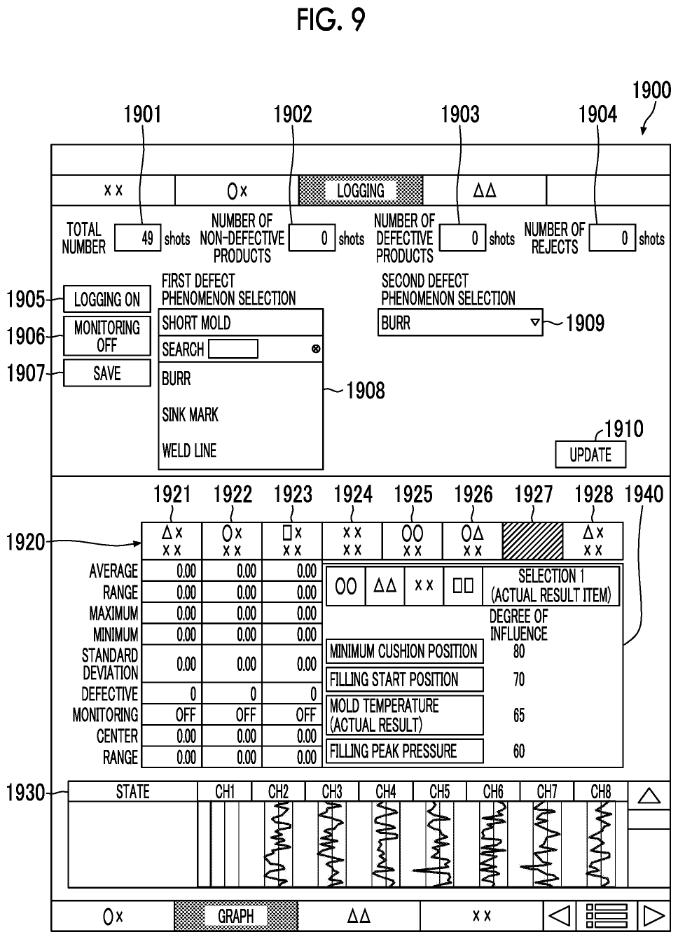

FIG. 9 is a view illustrating a log information screen output by the control device 700 of the injection molding machine 3 according to the present modification example.

In a log information screen 1900 shown in FIG. 9, a total number 1901, a number of non-defective products 1902, a number of defective products 1903, a number of rejects 1904, a logging button 1905, a monitoring setting button 1906, a save button 1907, a first molding product defect phenomenon selection field 1908, a second molding product defect phenomenon selection field 1909, an update button 1910, a statistics list 1920, and an actual result graph field 1930 are shown.

The statistics list 1920 shows statistical values (for example, average, range, maximum, minimum, integral, standard deviation, and the like) for each of setting fields 1921 to 1928. Contents shown in the setting fields 1921 to 1928 can be set by the user. In the present modification example, the setting items and the actual result items can be set in the setting fields 1921 to 1928. In the present embodiment, it is possible to display and monitor the items shown in the setting fields 1921 to 1928 and to save log information. The monitoring of the present embodiment represents a determination of whether or not the molding product is a non-defective product based on a predetermined criterion.

“Monitoring”, “center”, and“range” in the statistics list 1920 are information for determining whether or not the molding product is defective in the setting field. Regarding “monitoring”, “monitoring” set to “ON” for performing monitoring or set to “OFF” for not performing monitoring is performed by the monitoring setting button 1906. For example, a case not included in a range indicated by “range” from a value indicated by “center” is determined to be defective.

The monitoring setting button 1906 indicates that monitoring is not performed in a case where monitoring is “OFF” and monitoring is performed in a case where monitoring is “ON”. In the case of “ON”, the control device 700 performs monitoring of whether or not the measured actual value or the set value in each of the setting fields 1921 to 1928 satisfies criteria indicated by “monitoring”, “center”, and “range”.

“Defective” in the statistics list 1920 represents the number of molding products that do not satisfy the criteria shown in “monitoring”, “center”, and “range”.

The setting fields 1921 to 1928 are set as items to be monitored (for example, setting items and actual result items) in the cycle, filling, and plasticizing of the injection molding machine 3.

The input receiving unit of the control device 700 receives a change in an item for the setting fields 1921 to 1928. In a case where the selection of any one of the setting fields 1921 to 1928 (for example, the setting field 1927) is received, the display control unit of the control device 700 displays a selectable item list 1940.

It is difficult for an inexperienced operator to appropriately select an item requiring monitoring from the item list 1940. Therefore, in the present modification example, the input receiving unit 211 receives the selection of the defect phenomenon from the first molding product defect phenomenon selection field 1908 and the second molding product defect phenomenon selection field 1909.

In a case where the input receiving unit receives the pressing of the update button 1910 after receiving the selection of the defect phenomenon in the first molding product defect phenomenon selection field 1908 and the second molding product defect phenomenon selection field 1909, the display control unit displays items in descending order of the degree of influence on the selected defect phenomenon in the selectable item list 1940. In the example shown in FIG. 9, the actual result items are displayed in descending order of the degree of influence on the defect phenomenon “short mold”.

As the input receiving unit receives switching of tabs shown in the list 1940, the display control unit can display items having a high degree of influence on the selected defect phenomenon in the first molding product defect phenomenon selection field 1908 or the second molding product defect phenomenon selection field 1909 in a selectable manner. In other words, by receiving the switching of the tab from the operator, the display control unit can display a setting item having a high degree of influence on the defect phenomenon “short mold”, a setting item having a high degree of influence on the defect phenomenon “burr”, an actual result item having a high degree of influence on the defect phenomenon “burr”, and the like. These setting items and actual result items are displayed in order of the degree of influence.

Then, the input receiving unit receives the selection of the setting item or the actual result item displayed in the item list 1940. Accordingly, the items set in the setting fields 1921 to 1928 can be updated.

The actual result graph field 1930 shows a graph of the set values in the setting fields 1921 to 1928 or the actual value measured by various sensors for each shot.

The logging button 1905 is a button for accepting whether or not at least one of set values and the actual values shown in the actual result graph field 1930 is to be saved as the log information. In a case where the logging button 1905 is pressed (displayed as “LOGGING ON”), the control device 700 saves the information or the like shown in the actual result graph field 1930 in the storage medium 702 as log information.

The monitoring setting button 1906 is a button for accepting whether or not monitoring is to be performed according to the item monitored in the statistics list 1920. Ina case where the monitoring setting button 1906 is pressed (displayed as “MONITORING ON”), whether or not the molding product is a defective product is monitored for each shot, and the monitoring result is included in the log information.

The save button 1907 is a button that for accepting whether or not to save the statistical values (for example, average, range, maximum, minimum, integral, standard deviation, and the like) for each of the setting fields 1921 to 1928. In a case where the save button 1907 is pressed, the statistical values for each of the setting fields 1921 to 1928 at the time of molding are saved as log information.

The total number 1901 shows the number of molding products molded in the injection molding machine 3. The number of non-defective products 1902 indicates the number of molding products determined to be non-defective products based on “monitoring”, “center”, and “range”. The number of defective products 1903 indicates the number of molding products determined to be defective products based on the “monitoring”, “center”, and “range”. The number of rejects 1904 indicates the number of rejected molding products.

When the control device 700 according to the present embodiment includes the above-described configuration, the items (setting items or actual result items) related to the defect phenomenon can be easily set in the injection molding machine 3. Therefore, monitoring of the set value of the setting item or the actual value of the actual result item, which is related to the defect phenomenon, is facilitated.

Also in the present modification example, as in the above-described embodiment, in a case where the selection of the setting item is received in a certain setting field (for example, the setting fields 1921 to 1928) after the selection of the defect phenomenon is received, an actual result item having a high degree of relation to the setting item of which the selection is received may be automatically selected in the adjacent setting field.

Similarly, in the present modification example, the degree of influence may be changed as in the above-described embodiment. As described above, the injection molding machine 3 can execute the processing that can be performed by the management device 2, and description thereof will be omitted.

<Actions>

In the above-described embodiment and modification examples, the aggregated data of the injection molding machine 3 and peripheral units can be displayed as the analysis screen, the quality management screen, or the log information screen. Therefore, the operator can easily identify a situation of molding.

Hitherto, there has been a demand for an operator to easily investigate a cause of a defect in a molding product manufactured by an injection molding machine. In addition, in an injection molding machine, there has been a demand that data (for example, a setting item or an actual result item) having a high correlation with a defect phenomenon of a molding product should be easily monitored without specialized knowledge.

In a technique in the related art, regarding such a demand, it is necessary for an operator to manually investigate items that are likely to be related to defect phenomena from a huge amount of data. In addition, not only does an operator without specialized knowledge need time, but also the operator has a difficulty in specifying an item corresponding to a defect phenomenon. Therefore, there is a possibility that specification of a period in which a defect phenomenon occurs and prevention of recurrence by subsequent quality data monitoring are insufficiently achieved, which may not lead to an improvement in molding product quality.

Contrary to this, in the above-described embodiment and modification example, when the setting item or the actual result item is selected in the analysis screen, the quality management screen, or the log information screen, by receiving the selection of the defect phenomenon, the number of selectable candidates can be narrowed down. Accordingly, the operator can identify the items related to the defect phenomenon. Therefore, the operator can easily select the item even if the operator is not an expert, so that an operation burden can be reduced.

In addition, in the above-described embodiment and modification example, the degree of influence of the setting item or the actual result item can be changed depending on a situation in which the injection molding machine 3 manufactures the molding product. Therefore, after the changing, when the selection of the defect phenomenon is received, a more appropriate setting item or actual result item can be presented, so that a burden on the operator can be reduced.

In addition, in the above-described embodiment and modification example, the degree of relation between the setting item and the actual result item is maintained. Therefore, in a case where the selection of any one of the setting item and the actual result item is received, the other of the setting item and the actual result item having a high relation can be presented. Accordingly, the operation burden on the operator can be reduced.

Hitherto, the embodiments of the injection molding display device, the injection molding machine, and the injection molding management device according to the present invention have been described. However, the present invention is not limited to the above-described embodiments. Various modifications, corrections, substitutions, additions, deletions, and combinations can be made within the scope of the appended claims. As a matter of course, all of these also belong to the technical scope of the present invention.

It should be understood that the invention is not limited to the above-described embodiment, but may be modified into various forms on the basis of the spirit of the invention. Additionally, the modifications are included in the scope of the invention.

What is claimed is:

1. A display device for injection molding comprising:
a receiving unit configured to receive a selection of a defect phenomenon of a molding product manufactured by injection molding; and
a display control unit configured to display a parameter associated with the defect phenomenon of which the selection is received, in a selectable manner,
wherein the receiving unit is further configured to receive a selection from the parameter, and
the display control unit is further configured to display information regarding the parameter of which the selection is received.

2. The display device for injection molding according to claim 1, further comprising:
a first storage unit that stores the defect phenomenon, the parameter, and a degree of influence indicating a degree of influence of the parameter on the defect phenomenon in association with each other,
wherein the display control unit is configured to display the parameter associated with the defect phenomenon of which the selection is received, based on the degree of influence.

3. The display device for injection molding according to claim 2, further comprising:
a changing unit configured to change the degree of influence stored in the first storage unit.

4. The display device for injection molding according to claim 3,
wherein the display control unit is configured to display display information for updating the degree of influence of the parameter, and
the changing unit is configured to change the degree of influence corresponding to the display information in response to an input operation on the display information.

5. The display device for injection molding according to claim 1, further comprising:
a second storage unit that stores a degree of relation between a first parameter and a second parameter,
wherein the display control unit is configured to, in a case where the receiving unit receives a selection of the first parameter, display information regarding the first parameter and information regarding the second parameter selected on the basis of the first parameter and the degree of relation.

6. An injection molding machine comprising:
the display device according to claim 1.

7. A management device for injection molding comprising:
the display device according to claim 1.
